(19) United States
(12) Patent Application Publication
(10) Pub. No.: US 2024/0118254 A1
(43) Pub. Date: Apr. 11, 2024

(54) PFAS ISOLATOR COLUMN SCOUTING

(71) Applicant: Waters Technologies Corporation, Milford, MA (US)

(72) Inventor: Kari L. Organtini, Millbury, MA (US)

(73) Assignee: Waters Technologies Corporation, Milford, MA (US)

(21) Appl. No.: 18/482,437

(22) Filed: Oct. 6, 2023

Related U.S. Application Data
(60) Provisional application No. 63/414,437, filed on Oct. 7, 2022.

(51) Int. Cl. G01N 30/96

(52) U.S. Cl. CPC G01N 30/96; G01N 2030/965

(57) ABSTRACT

Provided herein is a method and system for PFAS analysis using a liquid chromatography technique that employ a first column (e.g., an isolator column) and a second column (e.g., an analytical column), wherein at least one of the first column, the second column, or both the first and second columns include mixed mode with anion exchange surface chemistry. The devices and methods provided herein are useful for improving the efficiency and/or sensitivity of systems implementing liquid chromatography for PFAS analysis. The methods of the present disclosure are particularly beneficial for trace level (e.g., ppm level or lower) analysis of PFAS. Further, the methods of the present disclosure allow improved separation of short-chain and ultrashort-chain PFAS.

### RELATED APPLICATIONS

This application claims priority and benefit to U.S. Provisional Patent Application No. 63/414,437, filed on Oct. 7, 2022, and entitled “PFAS Isolator Column Scouting”, the content of which is incorporated herein by reference in its entirety.

### FIELD OF THE TECHNOLOGY

The present disclosure relates generally to a method of liquid chromatography that employs a first column (e.g., an isolator column) and a second column (e.g., an analytical column) for analysis of PFAS. In particular, the present technology relates to use of an isolator column for improving performance of systems implementing liquid chromatography. The method and system of the present technology requires utilizing a mixed mode with anion exchange surface chemistry in at least one of the first column, the second column, or both the first and second columns.

### BACKGROUND

Per- and polyfluorinated alkyl substances (PFAS) are compounds of increasing importance for a broad spectrum of industrial sites and waterways. They are known to be low in degradability and persist in the environment for a long time. This makes PFAS some of the most important environmental contaminants to monitor around the world. Their widespread use in a wide variety of commercial and industrial applications including textiles, paints, packaging materials, non-stick products, and water-repellant clothing and environmental persistence make them truly a global issue.

As more research is focused on PFAS exposure and impacts, analytical techniques have been advancing as well to help progress research and monitoring efforts. There have been numerous attempts reported in the literature to quantify PFAS in the environment. Both targeted and nontargeted MS-based analytical strategies have been employed for monitoring levels of PFAS in various matrices. Current analytical approaches are generally coupled with liquid chromatography systems to be able to separate PFAS from other compounds present in a sample matrix. However, PFAS are known to be used during the production of PTFE, which is a material that is used in tubing and other components of LC systems due to its inertness. The use of fluorinated coatings in the LC flow pathway and solvent storage bottles creates an environment where the mobile phase can become contaminated with PFAS and interfere with sample analysis. That is, the PFAS from tubing, sample and solvent storage and injection, and from components of the LC systems, produce a background level of PFAS which interfere or mask relevant information during MS analysis.

### SUMMARY

Background PFAS contamination can interfere with low-level quantification requirements in terms of health advisory levels, which are usually in the range of parts per trillion (ppt) or below, as well as give incorrect quantitative results in samples being analyzed. Instrument-related background contamination can stem from LC components that contain fluoropolymers (e.g., PTFE), which can leach into mobile phase solutions.

To address the foregoing problems, in whole or in part, and/or other problems that may have been observed by persons skilled in the art, the present disclosure provides methods and/or systems, as described by way of example in implementations set forth below.

In general, the present technology is directed to increasing performance of a liquid chromatography system that is used for analysis of PFAS.

In one aspect, provided herein is a method of PFAS analysis using a liquid chromatography system that employs a first column (e.g., an isolator column) and a second column (e.g., an analytical separation column). In some embodiments, the isolator column includes a stationary phase including mixed mode with anion exchange surface chemistry. In some embodiments, the analytical separation column includes a stationary phase including mixed mode with anion exchange surface chemistry. In some embodiments, both the isolator column and the analytical separation column (also known as analytical column) include a stationary phase including mixed mode with anion exchange surface chemistry. In some embodiments, surface chemistry of the stationary phase of the isolator column and the analytical column is independently selected from mixed mode with anion exchange surface chemistry and reversed phase chemistry. In one embodiment, reverse phase chemistry includes C₁₈ alkyl-bonded surface chemistry.

The methods and systems of the present technology leverages surface chemistry of the stationary phase of the isolator column introduced in a liquid chromatography system to improve chromatographic resolution of analytical PFAS peak.

The methods and systems provided herein allow reducing PFAS background noise from the LC system and/or from the mobile phase, which leads to increased sensitivity and accuracy of PFAS detection.

The methods provided herein efficiently delay elution of per- and polyfluorinated compounds (PFAS) released from pump parts, solvent lines and/or solvents that would interfere with detection and quantification of PFAS in samples, e.g., drinking water, food.

In one aspect, provide herein is a method for performing fluorinated compound analysis using a liquid chromatography system including an isolator column and an analytical column, the method comprising: flowing a mobile phase through the isolator column; introducing a liquid sample into the liquid chromatography system through a sample injection port, wherein the liquid sample comprises at least one type of fluorinated compound and the sample injection port is located downstream of the isolator column; eluting the liquid sample through the analytical column such that at least one type of the eluted fluorinated compound is separated as a separated component; and flowing the separated eluted component(s) to the detector, wherein the isolator column comprises a stationary phase material possessing a mixed mode with anion exchange surface chemistry.

Flowing the mobile phase through the isolator column results in background-related PFAS interferences being retained throughut the isolator column, so background-related PFAS interferences do not coelute with PFAS from the sample during analysis.

In some embodiments, at least one type of fluorinated compound is a polyfluoroalkyl substance.

In some embodiments, the number of carbon atoms present in the polyfluoroalkyl substance is between 2 to 18, between 2 to 6, between 3 to 18, between 3 to 10, between 3 to 8, between 3 to 6, between 3 to 5, between 4 to 6.

In some embodiments, the number of carbon atoms present in the polyfluoroalkyl substance is more than 3.

In some embodiments, the number of carbon atoms present in the polyfluoroalkyl substance is more than 2.

In some embodiments, at least one type of fluorinated compound comprises one or more phosphate group(s).

In some embodiments, the analytical column comprises a stationary phase material possessing mixed mode with anion exchange surface chemistry.

In some embodiments, the analytical column comprises a stationary phase material possessing reversed phase surface chemistry.

In some embodiments, the analytical column comprises a stationary phase material possessing C₁₈ alkyl-bonded surface chemistry.

In some embodiments, the detector is for performing mass spectrometry.

In some embodiments, the mass spectroscopy comprises a tandem quadrupole mass spectrometer or a time-of-flight mass spectrometer.

In some embodiments, an interior surface of the isolator column is coated with an alkylsilyl coating. The alkylsilyl coating presented herein is capable of preventing any interaction between the interior surface of the isolator column and an analyte (e.g., phoshate containing PFAS).

In some embodiments, the method further comprises quantification of at least one type of fluorinated compound after flowing the separated eluted component(s) to the detector. In one embidment, the concentration of at least one type of fluorinated compound in the liquid sample is less than 10 ng/L, less than 1 ng/L, less than 0.1 ng/L, less than 0.01 ng/L, and less than 0.001 ng/L.

In another aspect, provided herein is a method of delaying retention time of a contamination in liquid chromatography system comprising an isolator column and an analytical column, wherein the contamination comprises at least one type of first fluorinated compound, the method comprises: flowing a mobile phase through the isolator column, wherein the contamination is present in the system prior to the isolator column; introducing a liquid sample into the liquid chromatography system through a sample injection port, wherein the liquid sample comprises at least one type of second fluorinated compound and the sample injection port is located downstream of the isolator column; eluting the liquid sample through the analytical column such that at least one type of the eluted fluorinated compound is separated as a separated component; and flowing the separated eluted component(s) to the detector such that at least one type of second fluorinated compound reaches the detector prior to the at least one type of first fluorinated compound, thereby the retention time of the contamination is delayed at least 1 minute compared to the retention time of at least one type of second fluorinated compound.

In some embodiments, the isolator column comprises a stationary phase material comprising a mixed mode with anion exchange surface chemistry.

In some embodiments, the retention time of the contamination is delayed at least 5 minutes, at least 7 minutes, at least 8 minutes or more compared to the retention time of at least one type of second fluorinated compound.

In some embodiments, the first fluorinated compound and the second fluorinated compound are the same.

In another aspect, provided herein is a method for performing fluorinated compound analysis using a liquid chromatography system including an isolator column and an analytical column, the method comprising: flowing a mobile phase through the isolator column; introducing a liquid sample into the liquid chromatography system through a sample injection port, wherein the liquid sample comprises at least one type of fluorinated compound and the sample injection port is located downstream of the isolator column; eluting the liquid sample through the analytical column such that at least one type of the eluted fluorinated compound is separated as a separated component; and flowing the separated eluted component(s) to the detector, wherein at least one column comprises a stationary phase material possessing a mixed mode with anion exchange surface chemistry.

The devices and methods of the present technology provide numerous advantages. Particularly, the method of the present disclosure is useful for quantitative (e.g., trace level detection) and qualitative analysis of long-chain (>C6), short-chain (C4-C6) and ultrashort-chain PFAS (C2-C3). Further, the inner surface (wetted surfaces) of the columns (isolator and/or analytical column) of the present methods may be coated with the alkylsilyl coating that is able to prevent any interaction between the interior surface of the column and PFAS eluting through the columns. This allows sensitive and accurate analysis of phosphate containing PFAS which has a strong tendency to interact with an inner surface of the columns (e.g., a metal inner surface).

### BRIEF DESCRIPTION OF DRAWINGS

The technology will be more fully understood from the following detailed description taken in conjunction with the accompanying drawings, in which:

FIG. 1A and FIG. 1B show chromatograms of PFBA injected in a LC system that includes C₁₈ isolator column. The analytical peaks of PFBA are shown as internal standards in FIG. 1A. The solvent blank chromatogram of FIG. 1B belongs to a mobile phase spiked with 0.025 ng/L PFBA.

FIG. 1C and FIG. 1D show chromatograms of PFPeA injected in a LC system that includes C₁₈ isolator column. The analytical peaks of PFPeA are shown as internal standards in FIG. 1C. The solvent blank chromatograms of FIG. 1D belongs to a mobile phase spiked with 0.025 ng/L PFPeA.

FIG. 2 shows retention times of analyte PFBA and interference PFBA spiked into the mobile phase at a concentration of 0.025 ng/L injected in a LC system that includes a mixed mode isolator column.

FIG. 3A, FIG. 3B, and FIG. 3C show retention times for PFBA at various concentrations (0.01 ng/mL, 0.1 ng/mL, 1 ng/mL, respectively) in samples with a conventional C₁₈ isolator column when system related PFAS contamination is present in the mobile phase (spiked with 0.025 ng/L PFAS). FIG. 3A shows the results obtained using a conventional isolator column for PFBA at a concentration of 0.01 ng/mL; FIG. 3B shows the results obtained using the conventional isolator column for PFBA at the concentration of 0.1 ng/mL, and FIG. 3C shows the results obtained using the conventional isolator column for PFBA at a concentration of 1 ng/mL.

FIG. 3D show retention time for PFBA in samples with a C₁₈ mixed mode isolator column according to multiple embodiments of the present disclosure; wherein the PFBA is at a concentration of 0.01 ng/mL. FIG. 3E show retention time for PFBA in samples with a C₁₈ mixed mode isolator column according to multiple embodiments of the present disclosure; wherein the PFBA is at a concentration of 0.1 ng/mL. FIG. 3F show retention time for PFBA in samples with a C₁₈ mixed mode isolator column according to multiple embodiments of the present disclosure; wherein the PFBA is at a concentration of 1 ng/mL.

FIG. 4A, FIG. 4B and FIG. 4C show retention times of PFOA sample (analyte peak of internal standard) and system related PFOA contamination present in the mobile phase. When a mixed-mode anion exchange isolator column according to the present disclosure is used to analyze blank solvent spiked with 0.025 ng/L PFOA (FIG. 4A), the retention time difference between the background PFOA peak (spiked into the mobile phase to artificially mimic presence of a PFOA interference, FIG. 4C) and the sample peak is about 4 minutes. The retention time difference between the background PFOA peak (FIG. 4C) and the sample peak (FIG. 4B) is less than 1 minute when conventional C₁₈ isolator column was used.

FIG. 5A shows retention times of PFPrA and PFPrS analytes when conventional C₁₈ stationary phase is used as the analytical column for separation of PFPrA and PFPrS. FIG. 5B shows retention times of PFPrA and PFPrS when an exemplary mixed mode with anionic exchange stationary phase is used as the analytical column for separation of PFPrA and PFPrS. FIG. 5C shows retention time of various PFAS at varying chain length when an exemplary mixed mode with anionic exchange stationary phase is used as the analytical column.

FIG. 6A and FIG. 6B show analytical peak of perfluoroocatane sulfonamidoacetic acid (FOSAA) when different stationary phases are used for separation. FIG. 6A shows chromatograph of FOASAA run in an analytical column having a conventional reversed phase stationary phase.

FIG. 6B shows chromatograph of FOASAA run in an analytical column having an exemplary mixed-mode ion exchange stationary phase.

FIG. 7A and FIG. 7B show a retention comparison of trifluroracetic acid (TFA), PFPrA, PFBA, and PFPrS, labelled with retention times, on a reverse phase only column (FIG. 7A) and the mixed mode Atlantis™ Premier BEH C₁₈ AX Column (FIG. 7B). TFA is represented using an isotope labelled analog of TFA due to contamination issues with the native TFA analog.

FIG. 8A and FIG. 8B show a comparison of the retention of 46 PFAS on the Atlantis™ Premier BEH™ C₁₈ AX Column using a standard ammonium acetate gradient at constant pH (FIG. 8A) and the ammonium hydroxide gradient with varying pH (FIG. 8B).

FIG. 9A, FIG. 9B, FIG. 9C, and FIG. 9D show calibration curves for ¹³C₂-TFA, PFPrA, and PFPrS over the range of 5-200 ng/L (FIG. 9A-FIG. 9C), and a Waters_connect for quantitation overview page highlighting important American Society for Testing and Materials (ASTM) data quality guidelines such as residuals, calibration, quality controls, and blanks (FIG. 9D). TFA is represented using an isotope labelled analog of TFA due to contamination issues with the native TFA analog.

FIG. 10A and FIG. 10B show overlap of PFPrA retention in different types of samples (e.g., metal finisher, leachate, and pulp and paper sample) without (FIG. 10A) and with (FIG. 10B) additional pH adjustment.

FIG. 11A, FIG. 11B, FIG. 11C, and FIG. 11D show retention time stability of different classes of PEAS on the Atlantis™ Premier BEH™ C₁₈ AX Column. FIG. 11A provides the results for dNMeFOSE; FIG. 11B provides the results for 13C8-PFOA; FIG. 11C provides the results for 13C8-PFOS; and FIG. 11D provides the results for 13C3-HFPO-DA.

FIG. 12A and FIG. 12B show performance of the method described herein against an Environmental Resource Associates (ERA) certified reference material comparing the results obtained running on both the mixed mode column (C₁₈ AX) and reverse phase column.

FIG. 13A shows a zoomed-in chromatogram of the landfill leachate sample showing the elution of C₂-C₆ carboxylates on the C₁₈ AX column; whereas FIG. 13 B shows zoomed-in chromatogram of the landfill leachate sample showing the elution of C₂-C₆ carboxylates on a reverse phase column. The co-eluting peaks that cause the higher PFBA quantitation on the reverse phase column and are resolved on the C₁₈ AX column are circled TFA and PFHxA peaks are cut off due to the zoom.

### DETAILED DESCRIPTION

Following below are more detailed descriptions of various concepts related to, and embodiments of, methods and systems for preventing and detecting PFAS interference and ensuring accurate trace-level analysis of PFAS in samples.

It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

PFAS are a family of synthetic chemicals that have been produced since the late 1940s. PFAS contain multiple fluorine (F) atoms in place of hydrogen (H) atoms. Perfluorooctanoic acid (PFOA) and perfluorooctane sulfonate (PFOS) are the two most widely recognized, environmentally relevant PFAS; although there are thousands of PFAS of potential significance, and little is known about the toxicology of these compounds. The molecular structures of PFAS typically comprise: (a) a hydrophobic carbon chain (prevalently, but not limited to, 2-18 carbons in length), in which either all (i.e., per-) or part (i.e., poly-) of the hydrogens are substituted by fluorine atoms such that they include no less than one fluoroalkyl moiety (CₙF₂ₙ₊₁); and (b) hydrophilic polar functional groups such as carboxylates, sulfonates, sulphonamides, phosphonates and alcohols.

The small atomic size and robust electronegativity of fluorine affords unique properties to PFAS, such as extraordinary stability, strong acidity, high surface activity at very low concentrations, and/or water- and oil-repellency in comparison with their hydrocarbon counterparts. Hence, a broad range of industries have exploited PFAS as processing additives and as surfactants. Common consumer products that utilize PFAS consist of fire-fighting foams, metal plating, non-stick cookware, medical devices, sample preparation and storage devices, specialized garments and textiles, and stain repellents.

The PFAS family consists of more than 4000 individual compounds and three subclasses; ultra-short-chain PFAS (C=2-3), short-chain PFAS (C=4-7), and long-chain PFAS (C>7) where C is carbon number. Previous studies have indicated that long-chain PFAS have a higher potential to bioconcentrate and bioaccumulate as compared to ultra-short-chain and short-chain PFAS, which generally exhibit higher water solubility and more mobility. Thus, long-chain PFAS, in particular, perfluorooctanoic acid (PFOA) and perfluorooctanesulfonate (PFOS), have received worldwide attention in the scientific and regulatory community and among the public since the late 1990s, due to their bioaccumulation potential, persistence, toxicity, and ubiquitous presence in the environment.

Because of widespread applications, PFAS have been identified in industry facilities, commercial household products, drinking and wastewater, human food, and even living organisms. Contact with PFAS, even at trace level, may result in PFAS accumulation in human blood since carbon-fluorine bonds are highly resistant to breakdown. Therefore, PFAS are bio-accumulative in wildlife and humans because they typically remain in the body for extended periods of time. Accordingly, interest has rapidly grown in testing for these compounds.

Both targeted and nontargeted analytical approaches have been used for monitoring levels of PFAS. The non-targeted analysis may be chosen among a (high-resolution) mass spectrometry analysis, combustion ion chromatography (CIC), Particle-induced gamma ray emission spectroscopy (PIGE), fluorine nucleic magnetic resonance (NMR) and their combination. The targeted analysis may be chosen among high resolution spectrometry methods (FIRMS, e.g., quadrupole time-of-flight; Q-TOF) or tandem mass spectrometry (MS/MS).

The methods of present technology including implementing LC systems may be coupled with both targeted and nontargeted analytical approaches used in the field monitoring levels of PFAS. Specifically, methods of the present disclosure are advantageous when they are couple to mass spectroscopy techniques to quantitively and/or qualitatively analyze PFAS in various samples.

However, PFAS are widely used in liquid-contacting parts of LC systems due to their inertness. Hence, in a standard liquid chromatography (LC) (e.g., HPLC, UHPLC) set-up, instrument related PFAS interferences released from pump parts, solvent lines and solvents can move through the system with the mobile phase and collect at the head of the analytical column between sample injections.

System-related PFAS contamination can be affected by factors such as instrument make and model, tubing and fitting materials, mobile phase solvent grade and storage conditions, and analytical method conditions.

While analyzing at trace levels (e.g., ppm levels or lower) and striving for sub-ppt level detection of PFAS, PFAS contamination from LC components can prevent accurate identification and quantitation of PFAS in samples.

To eliminate this issue, the present disclosure provides PFAS isolator column that delays system related PFAS, preventing them from interfering with sample analysis. This isolator column is a universal solution that can be used with any type of LC system with any analytical column (fully porous or superficially porous having suitable surface chemistry for PFAS separation).

The methods of the present disclosure is effective in analysis of target PFAS selected from, but not limiting to, the fluorinated compounds listed in Table 1.

TABLE 1
Most prevalent PFAS that are found in the environment

| | | | | | | |
|---|---|---|---|---|---|---|
| 11Cl-PF3OUdS | 6:8PFPi | FDEA | N-EtFOSAA | PFBS | PFHxDA | PFOS |
| 3:3FTCA | 7:3FTCA | FHEA | N-MeFBSE | PFDA | PFHxPA | PFPeA |
| 4:2 FTS | 8:2 FTS | FHUEA | N-MeFOSAA | PFDPA | PFHxS | PFPeS |
| 5:1:2FTB | 8:2 PAP | FHxSA | N-TAmp-FHxSA | PFDS | PFMBA | PFTrDS |
| 5:3FTB | 8:2 diPAP | FOEA | NEtFOSA | PFDoDA | PFMPA | PFTreDA |
| 5:3FTCA | 8:8PFPi | FOSA | NEtFOSE | PFDoDS | PFNA | PFTriDA |
| 6:2 FTS | 8CL-PFOS | FOSAA | NFDHA | PFEESA | PFNS | PFUnDA |
| 6:2diPAP | 9Cl-PF3ONS | FOUEA | NMeFOSA | PFHpA | PFOA | PFUNDS |
| 6:2PAP | ADONA | GenX | NMeFOSE | PFHpS | PFODA | PFecHS |
| 6:6PFPi | FBSA | N-AP-FHxSA | PFBA | PFHxA | PFOPA | SAmPAP |

The methods of the present technology employ a PFAS isolator column that can eliminate the detrimental impact of background PFAS interferences from instrument-related sources by retaining contaminants prior to the analytical column and eluting them only after the sample has been injected and the gradient elution has started. The elution delay between the target PFAS in the sample and the background PFAS from the LC system is enough to separate them sufficiently to allow for accurate quantification of the target compound in the sample.

In some embodiments, the elution delay between the target PFAS in the sample and the background PFAS from the LC system is at least 1 minutes, 3 minutes, 4 minutes, 5 minutes, 6 minutes, 7 minutes, 8 minutes, 10 minutes, 12 minutes, 15 minutes, 20 minutes, 30 minutes, or 60 minutes.

The PFAS isolator column of the present disclosure (e.g., XBridge™ Premier BEH™ C₁₈ AX Column, commercially available from Waters Corporation, Milford MA) benefits from a mixed mode with anion exchange surface chemistry to efficiently delay the PFAS background contamination that originates from the instrument and therefore prevents co-elution with the PFAS compounds present in the sample.

The mixed mode with anion exchange mixed mode surface chemistry of the stationary phase of the isolator column offers excellent retention for PFAS background (including long-chain, short-chain and ultrashort-chain PFAS) to achieve a baseline separation between the background peaks and the peaks from the samples or standards injected. At the same time, the stationary phase of the present isolator column does not retain the background analytes too much (e.g., more than an hour), so after a short time (e.g., less than an hour) of running a high organic ratio of the mobile phase though it at the end of a gradient run, the isolator column is flushed and ready for the next analysis run.

As used herein, “mixed-mode chemistry” refers to chemical groups or moieties resulting in more than one form of interaction between the stationary phase and analytes to achieve separation of the analytes. Mixed-mode chemistry is a promising technique for accessing novel separation selectivity of PFAS. Specifically, mixed-mode with anion exchange chemistry of the present disclosure is useful for improving retention of short-chain and ultrashort-chain of PFAS.

The stationary phase material of the present disclosure comprising a mixed mode with anion exchange surface chemistry comprises one or more group(s) that can undergo any type of ionic interaction (e.g., electrostatic interactions) with an analyte e.g., PFAS.

The term “anion exchange” refers to any functional group that can be converted to a charged group by protonation with an acid or deprotonation with a base.

In some embodiments, the mixed mode with anion exchange chemistry comprises one or more hydrophobic groups. In some embodiments, the hydrophobic group of the mixed mode with anion exchange surface chemistry of the present disclosure is a C₄ to C₃₀ bonded phase. In certain embodiments, the hydrophobic group is a C₁₈ bonded phase. In other embodiments, the hydrophobic surface group is an aromatic, phenylalkyl, fluoro-aromatic, phenylhexyl, pentafluorophenylalkyl or chiral bonded phase. In one embodiment, the hydrophobic surface group is an embedded polar bonded phase.

The stationary phase material disclosed herein may be in the form of a particle, a granular material, a monolith, a superficially porous material, a superficially porous particle, a superficially porous monolith, or a superficially porous layer for open tubular chromatography.

The stationary phase material of the isolator and the separator column of the present disclosure may be selected independently, for example, from inorganic material (e.g., silica, alumina, titania, zirconia), a hybrid organic/inorganic material, an inorganic material (e.g., silica, alumina, titania, zirconia) with a hybrid surface layer, a hybrid material with an inorganic (e.g., silica, alumina, titania, zirconia) surface layer, or a hybrid material with a different hybrid surface layer.

In some embodiments, the stationary phase material of this technology (e.g., the stationary phase of an isolator column or an analytical column) has an average pore diameter of about 20 to 1500 Å; about 50 to 1000 Å; about 100 to 750 Å; or about 110 to 500 Å.

In some embodiments, when the stationary phase is in the form of a particle, the stationary phase has an average particle size of about 0.3-100 μm; about 0.5-20 μm; 0.8-10 μm; 1.0-3.5 μm; or about 3.5-5.0 μm. In one embodiment, the stationary phase has an average particle size of about 5.0 μm.

### EXAMPLES

Instrument-related PFAS interferences move through the LC system with the mobile phase and collect at the head of the analytical column between sample injections. However, an isolator column added into the mobile phase flow path immediately before the injection valve is an effective way catch the background PFAS contamination before background PFAS reach the analytical column. If the background PFAS (e.g., contamination due to PFAS released from LC parts or PFAS present in mobile phase) are trapped using an isolator column in accordance with the present technology, when the sample is injected into a LC system, only the PFAS in the sample will focus at the head of the analytical column—as the background PFAS are trapped. Then, during the course of a gradient analysis, PFAS from the sample will begin to move through the analytical column for analysis. The background PFAS trapped in the isolator column during equilibration will be eluted and pass through the analytical column as well. However, the background PFAS will elute later than the sample PFAS because they entered the analytical column after the injected sample due to additional retention by the isolator column prior to reaching the injector. The net effect is that by using an isolator column you can differentiate instrument related PFAS background contamination from target PFAS in a sample.

The mobile phase composition used for analysis of PFAS solvents in the following examples include 2 mM ammonium acetate in water and 2 mM ammonium acetate in methanol in gradient format (e.g., composition varying 95%-5% by volume, composition varying 80%-1%).

### Example 1: The Effect of Conventional Isolator Column on Retention of Background PFAS

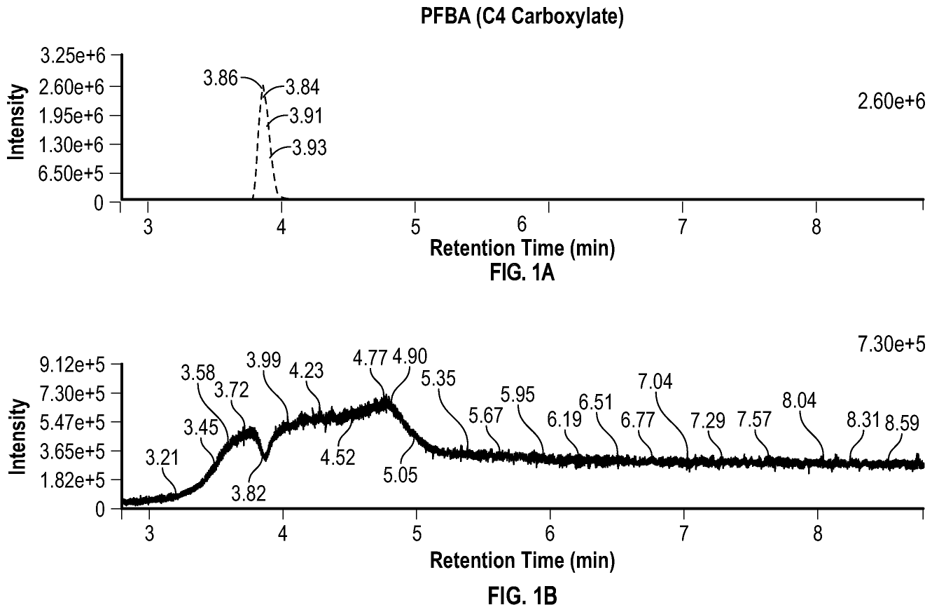

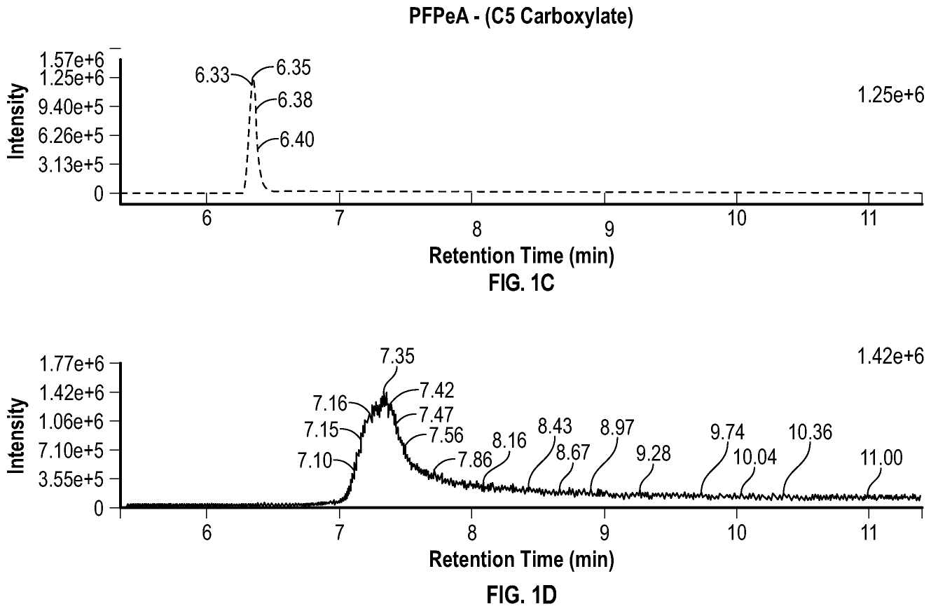

Current or conventional isolator columns used in the art (such as C₁₈ bonded columns upstream of an analytical column) are not effective in retaining background short-chain PFAS well. That is, the retention peak of background short-chain PFAS is not delayed much compared to the retention peak of the analyte PFAS. To illustrate this scenario, a mobile phase spiked with 0.025 ng/L PFBA (FIG. 1A, and FIG. 1B) and PFPeA (FIG. 1C and FIG. 1D) was injected in a LC system that includes C₁₈ isolator column. When retention time of the analytical peaks of PFBA and PFPeA (shown as internal standards in FIG. 1A and FIG. 1C are compared with corresponding PFAS contamination in the system (artificially created by spiking into the mobile phase FIG. 1B and FIG. 1D, it is seen that the shorter chain PFBA causes no delay. Further, the PFBA contamination in the system creates a background level that interferes with (i.e., masks) analysis (FIG. 1A and FIG. 1B). A comparison of FIG. 1C and FIG. 1D shows less than 1 minute delay of the retention peak of PFPeA, which may not be sufficient when analyzing trace levels of PFPeA.

### Example 2: The Effect of Mixed-Mode Isolator Column on Retention of Background PFAS

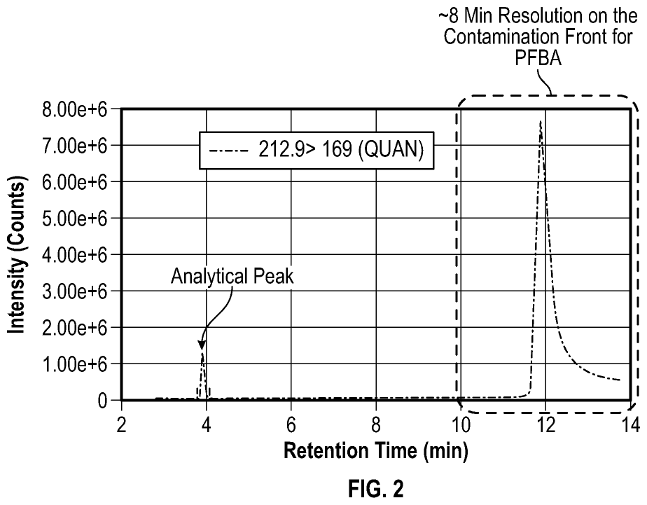

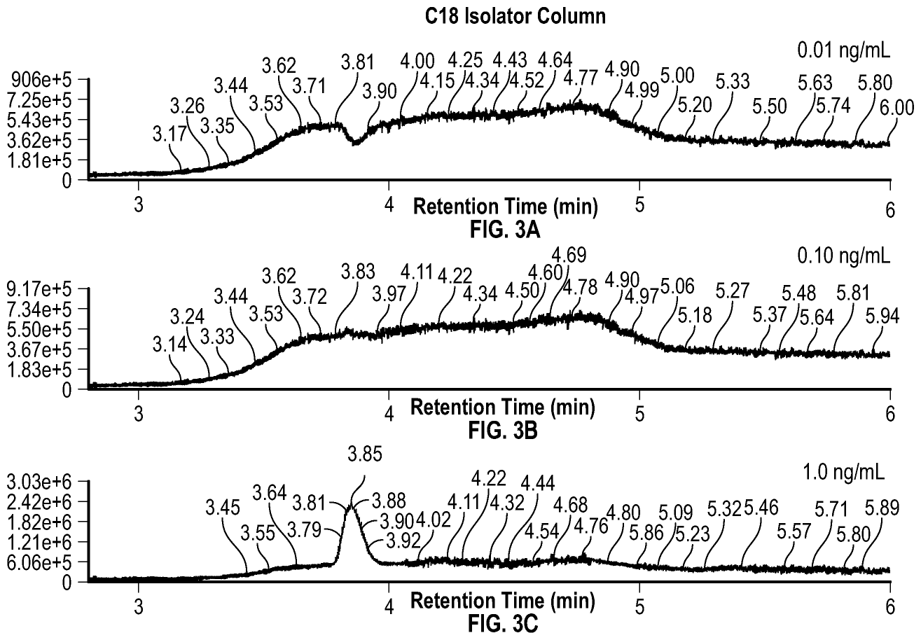

To prove the suitability of the mixed-mode with anion exchange surface chemistry isolator column presented herein (Atlantis™ Premier C₁₈ AX, available from Waters Corporation, Milford, MA), the method of the present disclosure was run with PFBA (Perfluorobutanoic acid) spiked to the aqueous mobile phase at a concentration of 0.025 ng/L to analyze PFBA of 1 ng/mL. The chromatogram in FIG. 2 shows a very good baseline separation of the analyte peak injected on column, resulting in improved chromatographic resolution of the analytical peak (e.g., the peak corresponding to target PFAS in a sample).

### Example 3: Comparison of Mixed-Mode Isolator Column and Conventional C₁₈ Isolator Column for PFBA

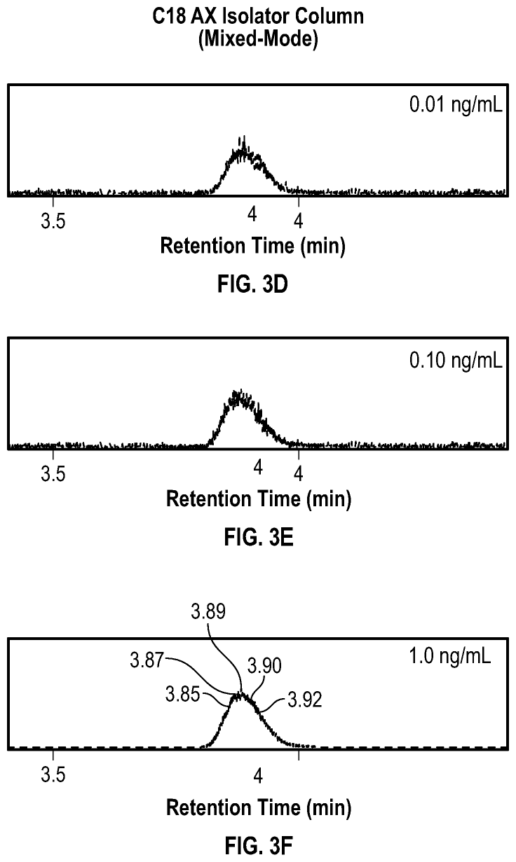

To compare the retaining power of conventional C₁₈ isolator column and the mixed-mode isolator column of the present disclosure, the mobile phase introduced into a LC system (Acquity™ Premier Solutions, available from Waters Corporation, Milford, MA) was spiked with 0.025 ng/L to analyze PFBA. By using the spiked mobile phase, three different concentrations of PFBA (0.01 ng/mL, 0.1 ng/mL and 1 ng/mL) were injected into the system through sample injection port (or valve). FIG. 3A to FIG. 3F show analytical peaks of PFBA in the presence of PFBA contaminant in the mobile phase. While the mixed-mode with anion exchange surface chemistry isolator column (Atlantis™ Premier C₁₈ AX, available from Waters Corporation, Milford, MA) shows well resolved analytical peaks even in the case of 0.01 ng/mL concentration (FIG. 3D), conventional C₁₈ isolator column (BEH™ C₁₈, available from Waters Corporation, Milford, MA) fails to sufficiently delay the retention peak of the PFBA present in the mobile phase (FIG. 3A, FIG. 3B, and FIG. 3C). Failure of conventional C₁₈ column to sufficiently delay the retention of PFBA creates a huge background contamination issue in the case of analyzing lower levels analytes (e.g., 0.01 ng/mL, 0.1 ng/mL). The analyte peaks of 0.01 ng/mL, 0.1 ng/mL PFBA are not resolved well to be quantitatively analyzed when conventional isolator C₁₈ column is implemented.

### Example 4: Comparison of Mixed-Mode Isolator Column and Conventional C18 Isolator Column for PFOA

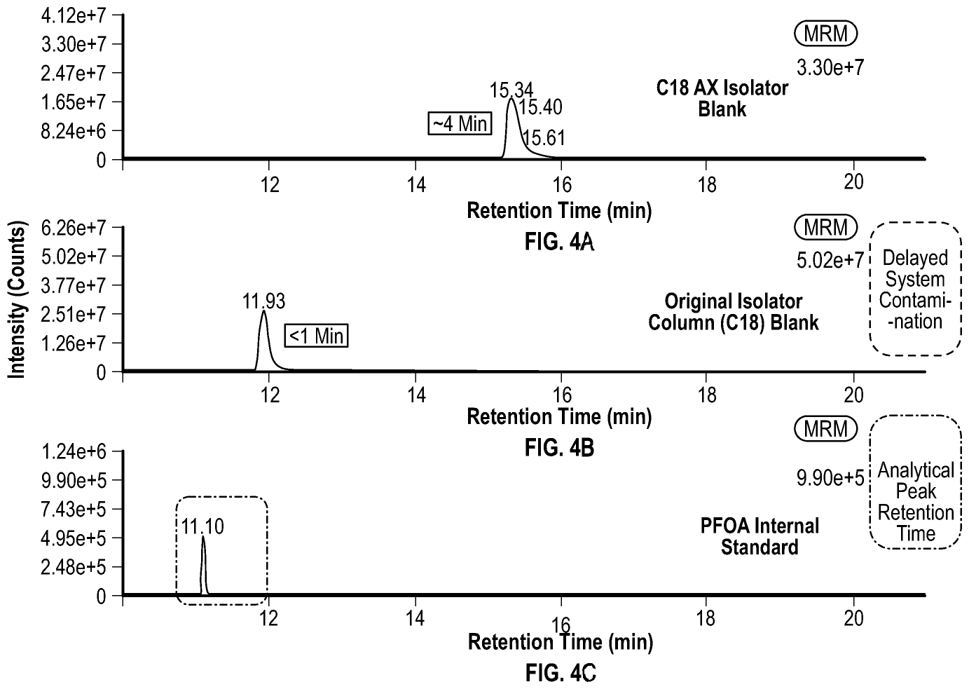

PFOA (Perfluorooctanoic acid) was spiked to the aqueous mobile phase at a concentration of 0.025 ng/L. Sample PFOA (C₁₃ labelled) of 1 ng/mL was separately run with a blank mobile phase to observe the retention time of the analytical peak. In this example a C₁₈ column (BEH™ C₁₈, available from Waters Corporation, Milford, MA) as the conventional column and a mixed-mode with anion exchange surface chemistry isolator column (Atlantis™ Premier C₁₈ AX, available from Waters Corporation, Milford, MA) in accordance with the present technology were compared. The chromatograms in FIG. 4A, FIG. 4B, and FIG. 4C show the retention time difference between the background PFOA peak (spiked into the mobile phase to artificially mimic presence of a PFOA interference, FIG. 4C) and the sample peak when two different isolator column was used (FIG. 4A and FIG. 4B). When it comes to analyzing longer chains (compared to for example PFBA), retention power of conventional column C₁₈ was improved. However, the retention time difference between the background PFOA peak and the sample peak caused by C₁₈ column is still less than (less than 1 minute) the retention time difference resulted from mixed mode column with anion exchange chemistry (about 4 minutes). That is, the isolator column of the present disclosure with a mixed mode with anion exchange chemistry improves resolution of the analytical peak better than the conventional isolator C₁₈ column.

### Example 5: Comparison of Mixed-Mode Isolator Column and Conventional C₁₈ Isolator Column for Retention of Ultrashort-chain PFAS

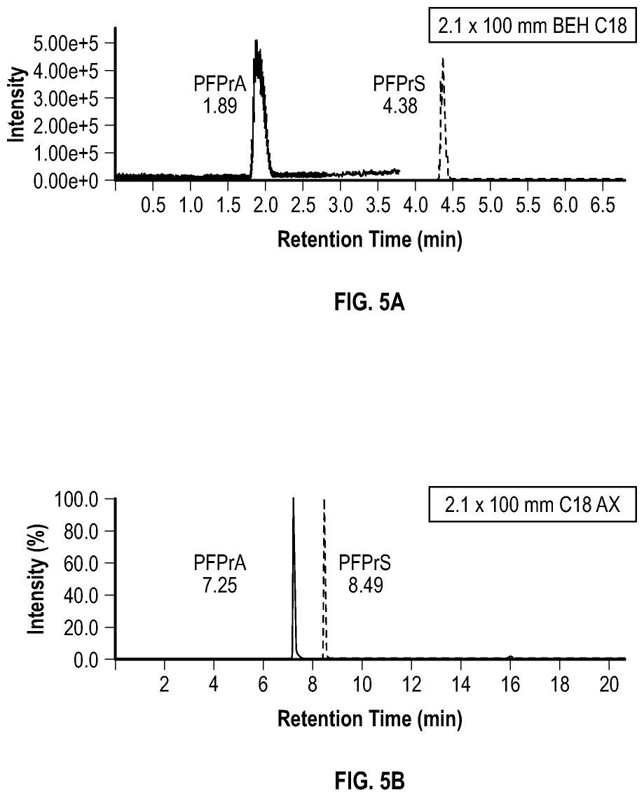

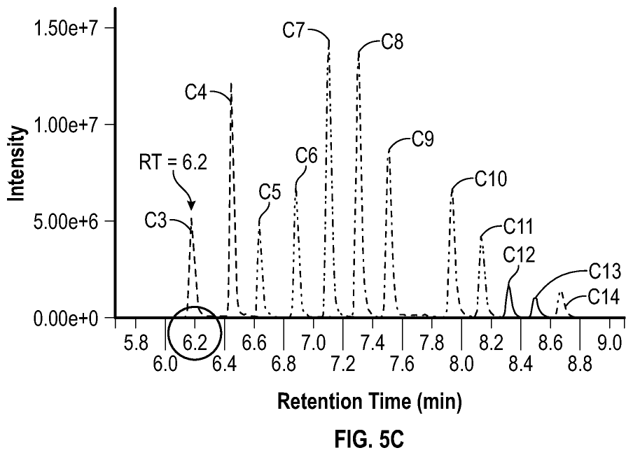

Analyzing ultrashort-chain PFAS (e.g., less than 4 carbon) has been challenging in the field since the conventional columns do not efficiently retain the ultra-short chain PFAS. FIG. 5C shows how retention of PFAS are increasing with increased chain length (carbon number). Two ultrashort-chain PFAS (PFPrA and PFPrS) were tested using two different stationary phases. FIG. 5A shows retention times of PFPrA and PFPrS when conventional C18 stationary phase (BEH™ C₁₈, available from Waters Corporation, Milford, MA) is used for separation of PFPrA and PFPrS. FIG. 5B shows retention times of PFPrA and PFPrS when mixed mode with anionic exchange stationary phase (Atlantis™ Premier C₁₈ AX, available from Waters Corporation, Milford, MA) is used for separation of PFPrA and PFPrS. The experimental parameters for this LC run are shown below in Table 2. As seen in FIG. 5B, retention times of PFPrA and PFPrS is greater than that of PFPrA and PFPrS shown in FIG. 5A. That is, a mixed mode with anionic exchange is more efficient in retaining ultrashort-chain PFAS than the conventional stationary phase.

Experimental Parameters

### Column XBridge™ Premier BEH™ C™ AX Column

Dimensions: 100 mm×2.1 mm ID

### Mobile Phase

A: Water, 2 mM ammonium acetate
B: Methanol, 2 mM ammonium acetate

TABLE 2
LC parameters

| Time | Flow | | | |
|---|---|---|---|---|
| (min) | (ml/min) | % A | % B | Curve |
| 0 | 0.3 | 95 | 5 | 6 |
| 1 | 0.3 | 75 | 25 | 6 |
| 6 | 0.3 | 50 | 50 | 6 |
| 13 | 0.3 | 15 | 85 | 6 |
| 14 | 0.3 | 5 | 95 | 6 |
| 17 | 0.3 | 5 | 95 | 6 |
| 18 | 0.3 | 95 | 5 | 6 |
| 22 | 0.3 | 95 | 5 | 6 |

### Example 6: Analysis of Sulfonamidoacetic Acid Containing PFAS with Mixed-Mode Ion Exchange Stationary Phase

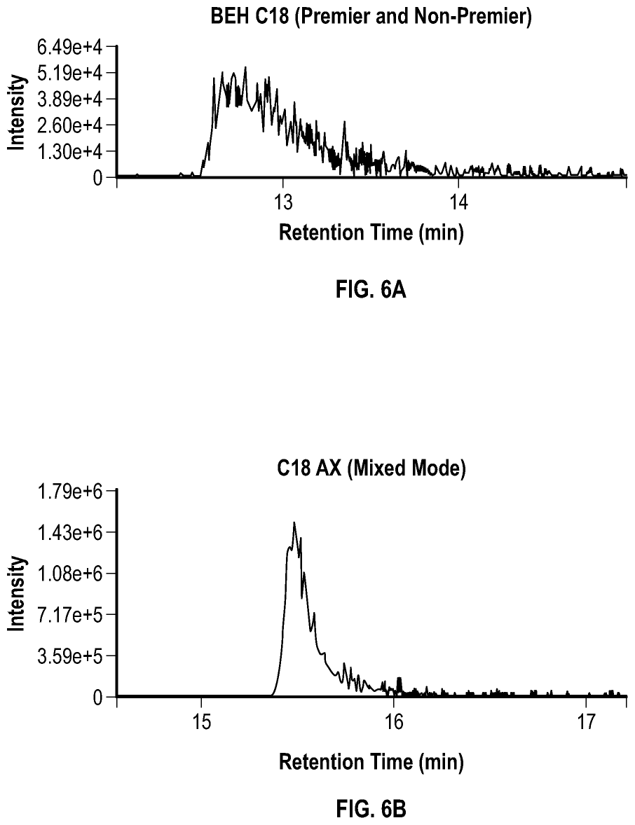

Perfluoroocatane Sulfonamidoacetic Acid (FOSAA) sample was run in an analytical column having a mixed-mode anionic exchange stationary phase (FIG. 6B) to evaluate its potential to retain sulfonamido acetic acid containing PFAS. Specifically, the sample of FIG. 6B was analyzed using a mixed mode with anionic exchange stationary phase (Atlantis™ Premier C₁₈ AX, available from Waters Corporation, Milford, MA). The column's interior surfaces are coated with an alkyl silyl coating. FIG. 6A and FIG. 6B show the delay in the retention time of FOSAA when mixed-mode surface chemistry is used (FIG. 6B) compared to the retention time of FOSAA eluted from conventional reversed phase column (e.g., BEH™ C₁₈) (FIG. 6A).

### Example 7: Analysis of Water Samples Provided by the U.S. Environmental Protection Agency (EPA) Region 5

Water samples were collected in the following locations: landfill leachate, a metal finisher, wastewater effluent, wastewater influent, hospital discharge, a bus washing station, a powerplant, pulp and paper factory, ground water, and surface water. A wastewater certified reference material from ERA (item number 404) was also analyzed alongside the collected water samples to evaluate the method performance using a certified material.

Water samples were prepared in accordance with the ASTM 8421 method (ASTM D8421-22). The entirety of each 5 mL water sample was used to avoid any compound loss from subsampling. Each sample was spiked with 160 ng/L of isotopically labeled surrogates. 5 mL methanol was then added to each water sample and vortexed. The entire 10 mL sample was syringe filtered using a 25 mm, 0.2 μm polypropylene syringe filter, Following filtration, 10 μL acetic acid was added to each sample. Additional acetic acid was added to samples that had a pH>4, as needed. An aliquot of each sample was transferred to a polypropylene autosampler vial for analysis on the Xevo™ TQ Absolute MS (available from Waters Technologies Corporation) coupled to an ACQUITY™ 1 Class FIN BSM System modified with a PFAS Kit (available from Waters Technologies Corporation).

Data Review

The data generated using the Atlantis™ Premier BEH™ C₁₈ AX Column was evaluated against the data quality guidelines outlined in ASTM 8421, which included the following:
1. A minimum 5-point linear calibration curve must be utilized.
2. Deviation (% error) of calibration standards and QC injections must be 30% of the expected concentration.
3 Blank response must be <50% of response of the LLOQ injection
4. Internal standard response must be within 30% of the median response of the batch.
5. Internal standard and native retention time must be within 5% (+/−3 sec) of die expected retention time.
6. Ion ratios must be within 30% of the mean reference peaks.

LC Conditions

LC system: ACQUITY I Class BSM with FTN

### Vials: 700 μL Polypropylene Screw Cap Vials (p/n:186005219)

Analytical column: Atlantis Premier BEH C18 AX 2.1×100 mm, 1.7 μm (p/n: 186009368)
Isolator column: Atlantis Premier BEH C18 AX 2.1×50 mm, 2.5 μm (p/n: 186009390)
Column temperature: 35° C.
Sample temperature: 10° C.
Injection volume: 30 μL
Flow rate: 03 mL/min
Mobile phase A: 2 mM ammonium acetate in water
Mobile phase B: 0.1% (v/v) ammonium hydroxide in methanol

TABLE 3
Gradient Table

| Time | | | |
|---|---|---|---|
| (min) | % A | % B | Curve |
| 0 | 99 | 1 | initial |
| 2 | 99 | 1 | 6 |
| 3 | 75 | 25 | 6 |
| 8 | 50 | 50 | 6 |
| 15 | 15 | 85 | 6 |
| 16 | 0 | 100 | 6 |
| 20 | 0 | 100 | 6 |
| 20.1 | 100 | 0 | 6 |
| 23.5 | 100 | 0 | 6 |
| 24 | 99 | 1 | 6 |

MS Conditions

MS system: Xevo™ TQ Absolute
Ionization mode: ESI
Capillary voltage: 0.5 kV
Source temperature: 100° C.
Desolvation temperature: 350° C.
Desolvation flow: 900 L/hr
Cone flow: 150 L/hr

Multiple Reaction Monitoring (MRM) Method

The full MRM method details are provided in the Table 4 below, wherein CE is collision energy and CV is cone voltage.

TABLE 4
MS Method conditions for PFAS included in analysis

| Compound | Precursor | Fragment | CV | CE |
|---|---|---|---|---|
| TFA | 112.9 | 68.9 | 8 | 10 |
| PFPrA | 162.9 | 118.9 | 10 | 10 |
| PFBA | 213.0 | 169 | 10 | 10 |
| PFPeA | 262.9 | 219 | 10 | 5 |
| PFHxA | 312.9 | 269 | 5 | 10 |
| | | 119 | 5 | 20 |
| PFHpA | 362.9 | 319 | 15 | 10 |
| | | 169 | 15 | 15 |
| PFOA | 412.9 | 369 | 10 | 10 |
| | | 169 | 10 | 15 |
| PFNA | 462.9 | 419 | 10 | 10 |
| | | 219 | 10 | 15 |
| PFDA | 512.9 | 468.9 | 15 | 9 |
| | | 219 | 15 | 15 |
| PFUnDA | 562.9 | 518.9 | 25 | 10 |
| | | 269 | 25 | 20 |
| PFDoDA | 612.9 | 568.9 | 30 | 10 |
| | | 169 | 30 | 25 |
| PFTriDA | 662.9 | 618.9 | 5 | 10 |
| | | 169 | 5 | 30 |
| PFTreDA | 712.9 | 668.9 | 10 | 25 |
| | | 169 | 10 | 15 |
| PFPrS | 248.9 | 80.1 | 15 | 30 |
| | | 99.1 | 15 | 30 |
| PFBS | 298.9 | 80.1 | 15 | 30 |
| | | 99.1 | 15 | 30 |
| PFPeS | 348.9 | 79.9 | 10 | 30 |
| | | 98.9 | 10 | 30 |
| PFHxS | 398.9 | 80.1 | 10 | 35 |
| | | 99.1 | 10 | 30 |
| PFHpS | 448.9 | 80.1 | 15 | 35 |
| | | 99.1 | 15 | 35 |
| PFOS | 498.9 | 80.1 | 15 | 40 |
| | | 99.1 | 15 | 40 |
| PFNS | 548.9 | 80.1 | 20 | 40 |
| | | 99.1 | 20 | 40 |
| PFDS | 598.9 | 80.1 | 46 | 46 |
| | | 99.1 | 46 | 46 |
| PFUnDS | 649.1 | 80 | 40 | 10 |
| | | 99 | 40 | 55 |
| PFDoDS | 699.1 | 80 | 40 | 55 |
| | | 99 | 40 | 55 |
| PFTrDS | 749.1 | 80 | 40 | 55 |
| | | 99 | 40 | 55 |
| GenX | 285.0 | 169 | 5 | 7 |
| (HFPO-DA) | | GenX | 5 | 35 |
| ADONA | 376.9 | 251 | 10 | 10 |
| | | 377.3 | 10 | 25 |
| 9Cl-PF3ONS | 530.9 | 350.9 | 15 | 25 |
| | | 82.9 | 15 | 25 |
| 11Cl-PF3OUsS | 630.9 | 450.9 | 30 | 30 |
| | | 631.2 | 30 | 30 |
| HQ-115 | 279.9 | 146.9 | 5 | 25 |
| | | 210.9 | 5 | 20 |
| 4:2 FTS | 326.9 | 306.9 | 15 | 15 |
| | | 327.3 | 15 | 35 |
| 6:2 FTS | 426.9 | 407 | 10 | 20 |
| | | 427.3 | 12 | 32 |
| 8:2 FTS | 526.9 | 506.8 | 15 | 25 |
| | | 527.3 | 15 | 37 |
| 3:3 FTCA | 241.0 | 116.9 | 5 | 40 |
| | | 176.9 | 5 | 10 |
| 5:3 FTCA | 340.9 | 216.9 | 5 | 25 |
| | | 237 | 5 | 10 |
| 7:3 FTCA | 440.9 | 316.9 | 10 | 22 |
| | | 337 | 10 | 17 |
| PFEESA | 314.9 | 82.9 | 15 | 20 |
| | | 134.9 | 15 | 20 |
| NFDHA | 295.0 | 84.9 | 5 | 10 |
| | | 200.9 | 5 | 10 |
| FOUEA | 456.9 | 393 | 20 | 11 |
| FHUEA | 356.9 | 292.9 | 20 | 12 |
| FOSA | 497.9 | 78 | 40 | 30 |
| N—MeFOSA | 511.9 | 168.9 | 40 | 30 |
| | | 218.9 | 40 | 25 |
| N—MeFOSE | 616.0 | 59 | 15 | 15 |
| N—EtFOSE | 630.0 | 59 | 15 | 15 |
| N—MeFOSAA | 569.9 | 418.9 | 35 | 25 |
| | | 219.1 | 35 | 20 |
| N—EtFOSAA | 584.0 | 418.9 | 15 | 25 |
| | | 525.9 | 15 | 25 |
| ¹³C₂-TFA | 114.9 | 69.9 | 8 | 10 |
| ¹³C₃-PFPrA | 165.9 | 120.9 | 10 | 10 |
| ¹³C₃-PFBA | 216.9 | 172 | 10 | 10 |
| ¹³C₅-PFPeA | 267.9 | 223 | 10 | 5 |
| ¹³C₅-PFHxA | 317.9 | 272.9 | 10 | 5 |
| | | 119.9 | 10 | 20 |
| ¹³C₄-PFHpA | 366.9 | 321.9 | 15 | 10 |
| | | 169 | 15 | 15 |
| ¹³C₈-PFOA | 420.9 | 375.9 | 5 | 15 |
| | | 172 | 5 | 10 |
| ¹³C₉-PFNA | 471.9 | 426.9 | 10 | 10 |
| | | 223 | 10 | 15 |
| ¹³C₆-PFDA | 519 | 473.9 | 5 | 10 |
| | | 219 | 5 | 15 |
| ¹³C₇-PFUnDA | 569.9 | 524.9 | 5 | 10 |
| | | 274 | 5 | 15 |
| ¹³C-PFDoDA | 614.9 | 569.9 | 10 | 10 |
| | | 169 | 10 | 25 |
| ¹³C₂-PFTreDA | 714.9 | 169 | 25 | 35 |
| | | 669.9 | 25 | 10 |
| ¹³C₃-PFBS | 301.9 | 80.1 | 10 | 30 |
| | | 99.1 | 10 | 25 |
| ¹³C₃-PFHxS | 401.9 | 80.1 | 10 | 40 |
| | | 99.1 | 10 | 35 |
| ¹³C₈-PFOS | 506.9 | 80.1 | 15 | 40 |
| | | 99.1 | 15 | 40 |
| ¹³C₈-FOSA | 505.9 | 78.1 | 35 | 25 |
| d-NMeFOSA | 514.9 | 168.9 | 40 | 30 |
| d-NEtFOSA | 531 | 168.9 | 5 | 25 |
| d7-NMeFOSE | 623 | 58.9 | 15 | 15 |
| d9-NEtFOSE | 639 | 58.9 | 15 | 15 |
| D₅-N—EtFOSAA | 589 | 418.9 | 30 | 20 |
| | | 506.9 | 30 | 15 |
| D₃-N—MeFOSAA | 572.9 | 418.9 | 35 | 20 |
| | | 482.7 | 35 | 15 |
| ¹³C₂-4:2 FTS | 328.9 | 308.9 | 40 | 15 |
| | | 81 | 40 | 25 |
| ¹³C₂-6:2 FTS | 428.9 | 409 | 10 | 20 |
| | | 80.9 | 10 | 27 |
| ¹³C₂-8:2 FTS | 528.9 | 508.9 | 10 | 20 |
| | | 81 | 10 | 35 |
| ¹³C₃-GenX | 287 | 169 | 5 | 12 |
| | | 119 | 5 | 12 |
| ¹³C₂-4:2 FTS | 328.9 | 308.9 | 40 | 15 |
| | | 81 | 40 | 25 |
| ¹³C₂-6:2 FTS | 428.9 | 409 | 10 | 20 |
| | | 80.9 | 10 | 27 |
| ¹³C₂-8:2 FTS | 528.9 | 508.9 | 10 | 20 |
| | | 81 | 10 | 35 |
| ¹³C₃-GenX | 287 | 169 | 5 | 12 |

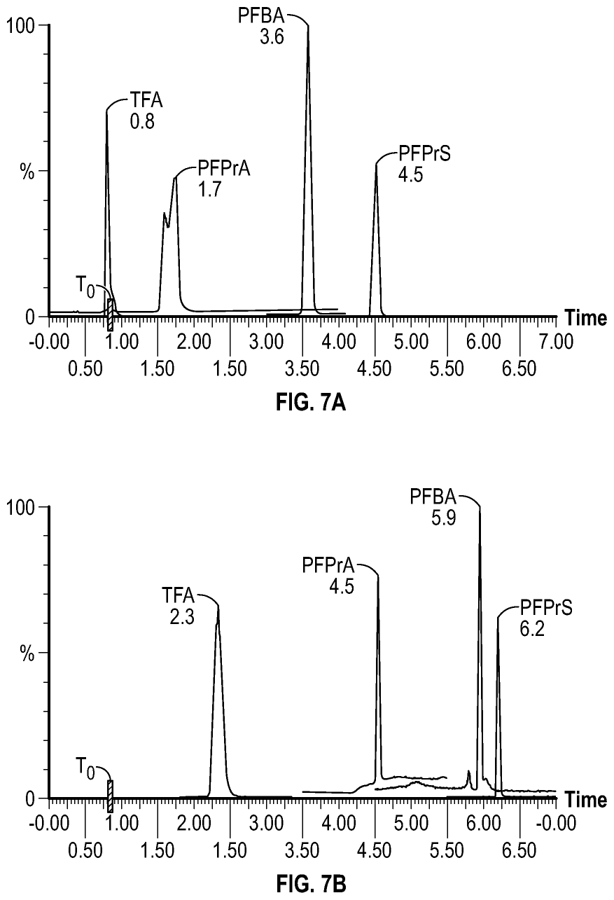

PFAS from the carboxylic acid family with chain lengths below C₄ are not sufficiently retained on standard reverse phase columns, as shown in the chromatogram in FIG. 7A. With the mixed mode Atlantis™ Premier BEH™ C₁₈ AX Column having both reverse phase and anion exchange mechanisms, the hydrophobicity of the C—F chain is not the only mode of retention for PFAS. The functional group, such as —CO₂ or —SO₄, also plays a role in retention, allowing for increased retention of the ultra-short chain PFAS like TFA and PFPrA where the C—F chain is not as hydrophobic as the longer chain PFAS. The chromatogram in FIG. 71B demonstrates the increased retention of the ultra-short chain PFAS on the Atlantis™ Premier BEH™ C₁₈ AX Column utilizing the gradient described herein.

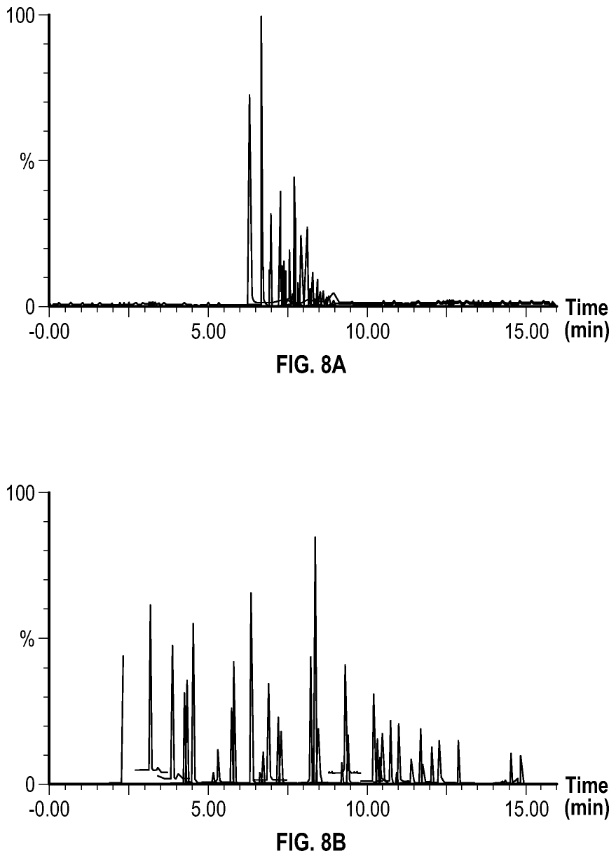

Standard PFAS gradient methods utilize aqueous and organic mobile phases that contain an additive, typically ammonium acetate, that remains at a consistent pH throughout the gradient. This is appropriate for reverse phase columns that retain compounds based solely on their hydrophobicity or polarity and utilize increased organic concentration over the gradient to separate compounds. In the case of a mixed mode column like the Atlantis™ Premier BEH™ C₁₈ AX Column, the anion exchange selectivity is utilized by varying pH over the gradient which essentially activates (retention) and deactivates (elution) the ion exchange sites on the column. Therefore, the best resolving power is gained when both organic composition and pH are varied over the gradient. FIG. 8A-FIG. 8B compare the chromatographic resolution of a selection of 44 PFAS on the Atlantis Premier BEH C₁₈ AX Column using a typical water/methanol with ammonium acetate gradient at a constant pH (FIG. 8A) to the resolution using a water/methanol with ammonium hydroxide gradient (FIG. 8B) that increases pH over the gradient run. In the ammonium acetate gradient, all 44 PFAS elute within an approximate 3-minute window. Utilizing ammonium hydroxide as a mobile phase additive to create a pH gradient increases the resolution over an elution window of approximately 13 minutes. Benefits from the increased chromatographic resolution include increased mass spectral data quality by allowing more dwell time for each MRM function, as well as decreased chances of matrix interference from co-eluting matrix compounds.

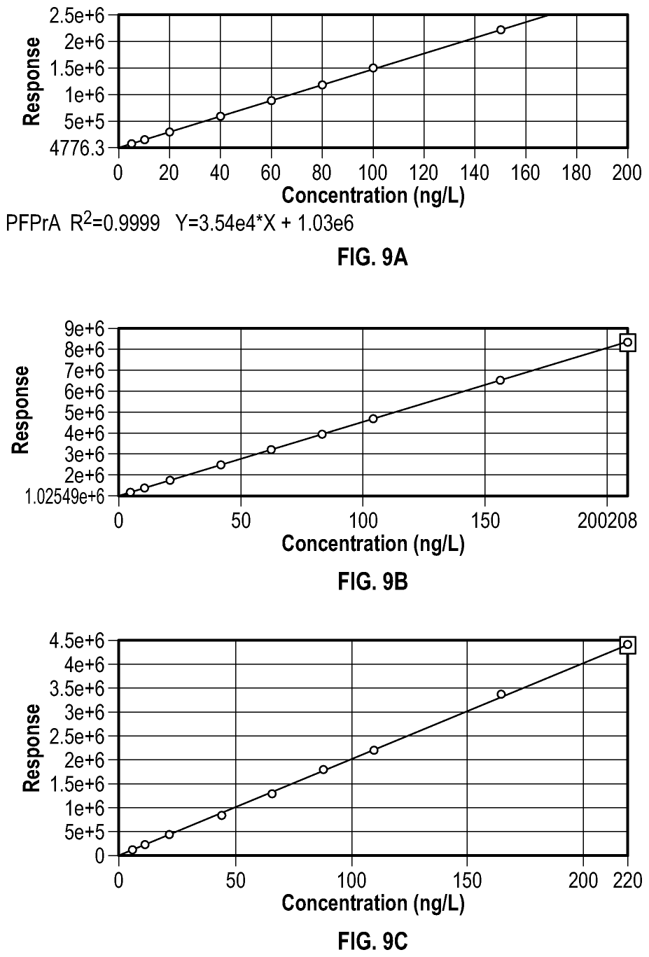

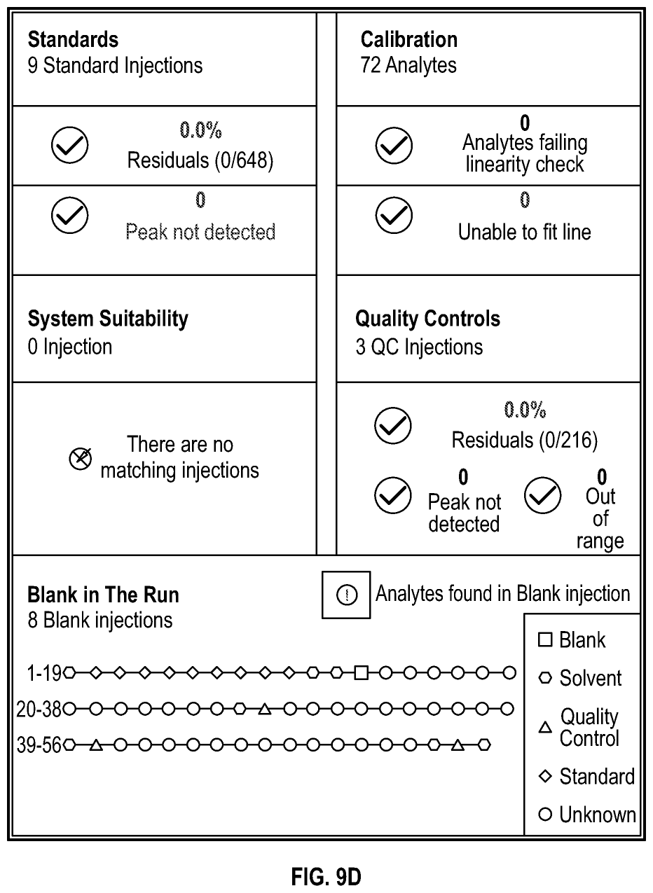

Calibration curves for ¹³C₂-TFA, PFPrA, and PFPrS over the range of 5-200 ng/L were prepared as show in FIG. 9A-FIG. 9C. TFA is represented using an isotope labelled analog of TFA due to contamination issues with the native TFA analog. A waters_connect for quantitation overview page highlighting important ASTM data quality guidelines such as residuals, calibration, quality controls, and blanks is shown in FIG. 9D.

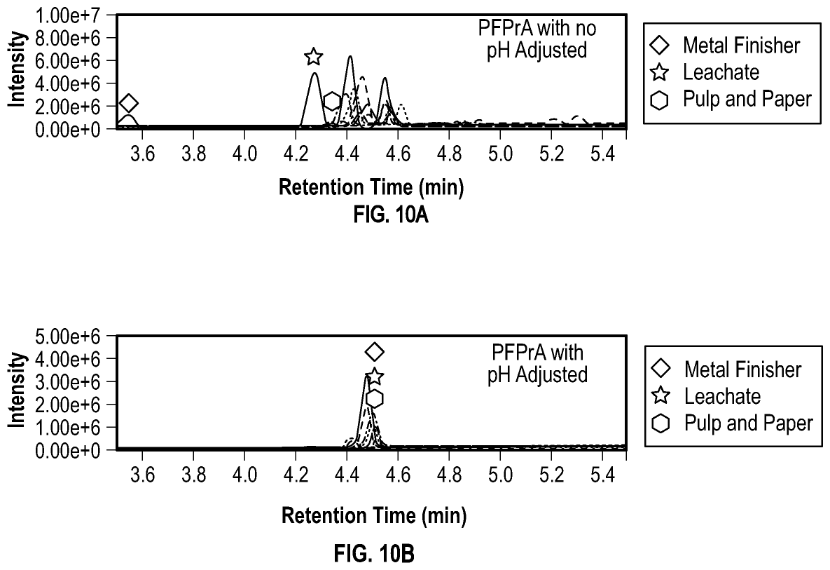

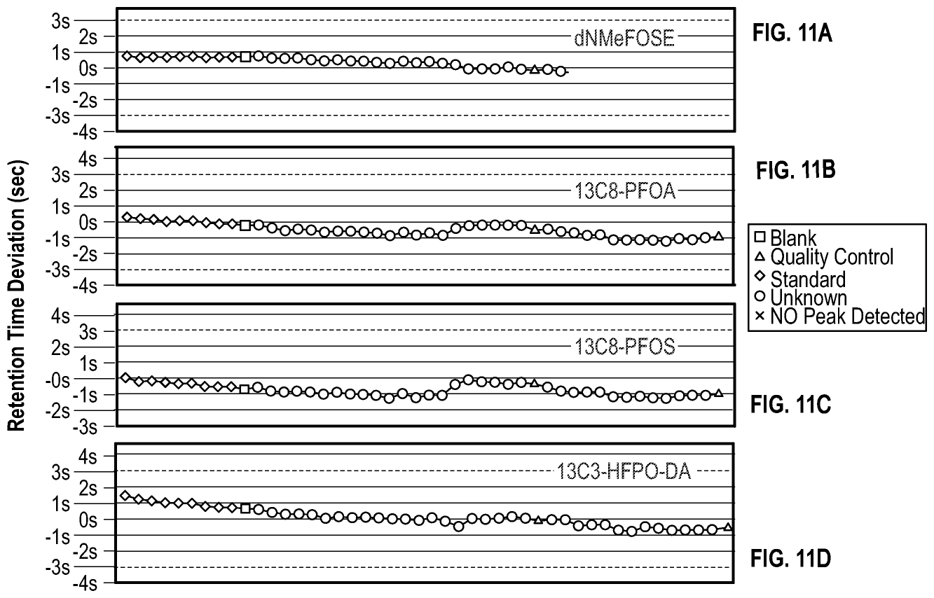

FIG. 10A shows an overlap of PFPrA retention in different types of samples without additional pH adjustment; whereas FIG. 10B illustrates the PFPrA retention times with additional pH adjustment. With all samples adjusted to the same nominal pH value, FIG. 10B demonstrates the retention times of the early eluting compounds are much more stable and fall within the 5% retention time tolerance. Additionally, compounds throughout the rest of the gradient are stable and well within the 5% retention time tolerance (FIG. 11A, FIG. 11B, FIG. 11C, and FIG. 11D).

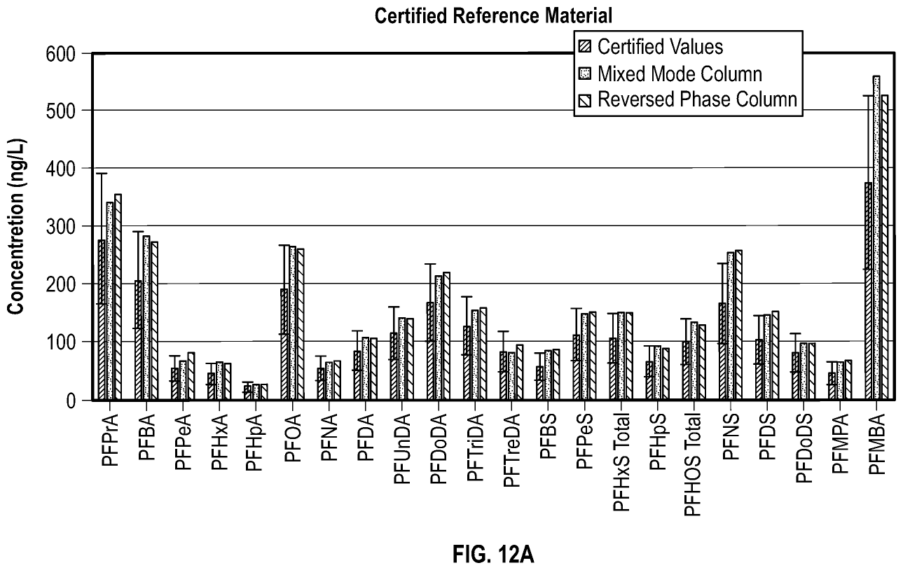

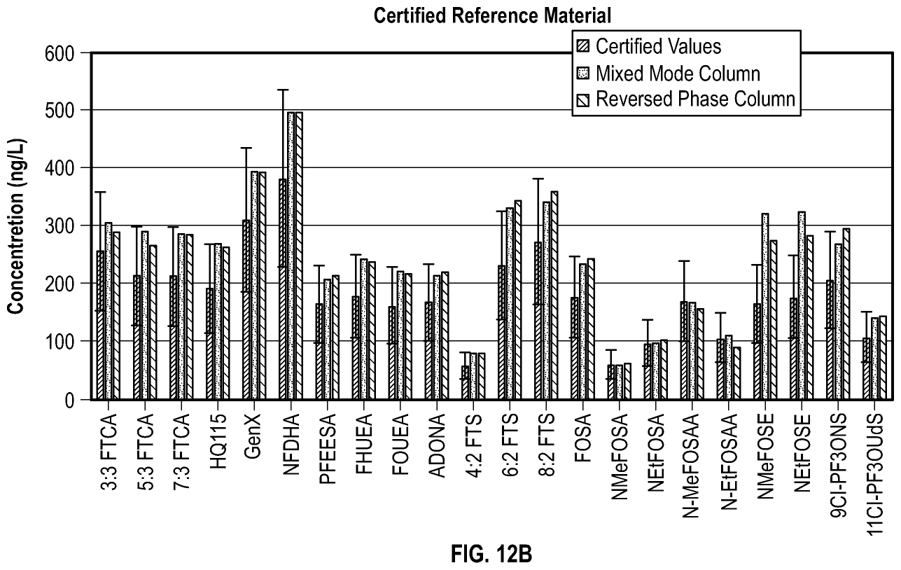

In addition to ensuring the data fell within the quality control guidelines of the ASTM 8421 method, a certified reference material was analyzed and quantified in the same batch as the water samples. The results are shown in FIG. 12 which also compares the quantified results from a reverse phase column. The mixed mode and reverse phase data are extremely comparable indicating that there are no major matrix components that co-elute using the C₁₈ AX Column and causing ion suppression or enhancement. Overall, the analysis of the wastewater CRM showed the mixed mode column analysis method to be accurate. Additionally, the mixed mode column analysis proved to be as accurate as the C₁₈ reverse phase only column.

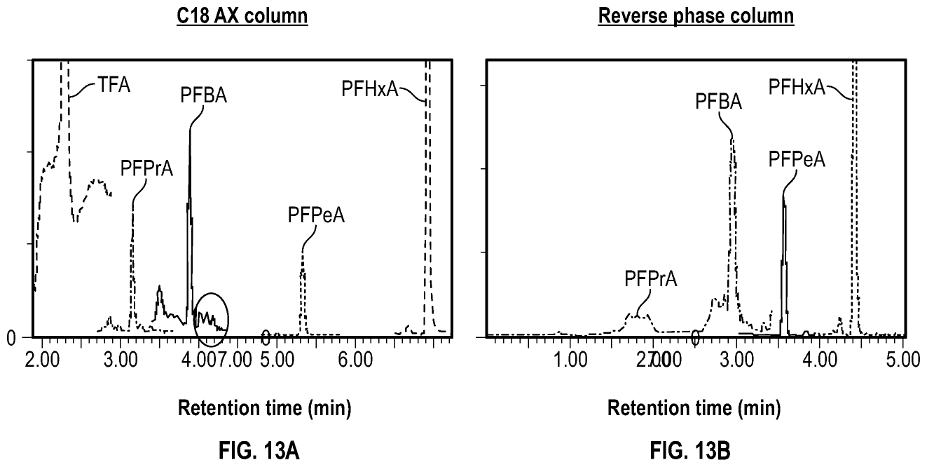

Upon analysis of the different sample types on the Atlantis™ Premier BEH™ C₁₈ AX Column, significant levels of TFA, PFPrA, and PFPrS were identified in the landfill leachate sample. Previous analysis of the samples using a reverse phase column (ACQUITY® BEH™ C₁₈ Column) only included PFPrA, which was poorly retained on the column. Without the inclusion of the ultra-short chain PFAS, made possible by the mixed mode chemistry of the Atlantis™ Premier BEH™ C₁₈ AX Column, significant amounts of PFAS would have been missed in the analysis of this sample. Not only were the ultra-short chain PFAS included using the mixed mode column, but the rest of the PFAS normally targeted in routine testing methods could also be analyzed on the same column, in the same single injection. Table 5 lists the quantified amount of each PFAS identified in the landfill leachate sample using both the reverse phase and mixed mode columns as well as the calculated percent difference. The percentage difference between both sets of quantified results was within 15% for all PFAS identified except for PFBA, which had a percent difference of 33%. The higher percent difference for PFBA is assumed to be a result of possible co-eluting peaks that were resolved using the C₁₈ AX column, causing an over-estimation of PFBA in the landfill leachate sample on the C₁₈ column, as highlighted in FIG. 13A. The peaks circled in the C₁₈ AX chromatogram (FIG. 13A) appear to cause peak broadening/slight peak tailing of PFBA in the reverse phase chromatogram (FIG. 13B).

TABLE 5
Quantitation of 46 PFAS compounds in a landfill leachate sample
using both the C₁₈ AX mixed mode Column and reverse phase Column

| | C₁₈ | Reverse | | | C₁₈ | Reverse | |
|---|---|---|---|---|---|---|---|
| | AX | Phase | % | | AX | Phase | % |
| Compound | (ng/L) | (ng/L) | Difference | Compound | (ng/L) | (ng/L) | Difference |
| TFA | 7790 | — | NA | PFMPA | 10.6 | 9.8 | 8.2 |
| PFPrA | 1063.6 | 1204 | 11.7 | PFMBA | 3 | 2.8 | 7.1 |
| PFBA | 1904.8 | 2853.2 | 33.2 | 3:3 FTCA | 183.8 | 210 | 12.5 |
| PFPeA | 3150.8 | 3351.4 | 6.0 | 5:3 FTCA | 6343.8 | 6176.2 | 2.7 |
| PFPxA | 5004.4 | 5002.4 | 0 | 7:3 FTCA | 151.4 | 147.4 | 2.7 |
| PFPpA | 743.2 | 682 | 9.0 | GenX | 4.2 | 4 | 5.0 |
| PFOA | 1431 | 1379 | 3.8 | NFDHA | ND | ND | ND |
| PFNA | 133 | 129.2 | 2.9 | PFEESA | ND | ND | ND |
| PFDA | 153.4 | 147.4 | 4.1 | FHUEA | 48.8 | 48.8 | 0.8 |
| PFUnDA | ND | ND | ND | FOUEA | ND | ND | ND |
| PFDODA | ND | ND | ND | ADONA | ND | ND | ND |
| PFTriDA | ND | ND | ND | 4:2 FTS | 42.2 | 40.4 | 4.5 |
| PFTreDA | ND | ND | ND | 6:2 FTS | 6829.2 | 7012.2 | 2.6 |
| PFPrS | 552 | — | NA | 8:2 FTS | 69.2 | 69.4 | 0.3 |
| PFBS | 4055.8 | 4293.4 | 5.5 | FOSA | 11 | 10 | 10.0 |
| PFPeS | 348 | 361 | 3.6 | NMeFOSA | ND | ND | ND |
| PFHxS | 1133.8 | 1158.4 | 2.1 | NEtFOSA | ND | ND | ND |
| PFHpS | 29.4 | 32.2 | 8.7 | N-MeFOSAA | 254.6 | 222.4 | 14.5 |
| PFOS | 452.8 | 454 | 0.3 | N-EtFOSAA | 76.4 | 71.4 | 7.0 |
| PFNS | ND | ND | ND | NMeFOSE | ND | ND | ND |
| PFDS | ND | ND | ND | NEtFOSE | ND | ND | ND |
| PFDoDS | ND | ND | ND | 9Cl-PF3ONS | ND | ND | ND |
| HQ115 | 689.6 | 639 | 7.9 | 11Cl-PF3OUdS | ND | ND | ND |

(ND) not detected, (NA) not applicable

By taking advantage of the hydrophobic and ionic nature of PFAS, the Atlantis™ Premier BEH™ C₁₈ AX Column was shown to successfully retain ultra-short chain PFAS, such as TFA and PFPrA, while maintaining the ability to analyze and quantify all other legacy, long chain PFAS in a single injection. The use of the Atlantis™ Premier BEH™ C₁₈ AX Column may allow laboratories to expand the suite of PFAS capable of analysis in a single injection from ultra-short chain through long chain PFAS on their current LC-MS/MS system.

The examples above show the superior properties of a mixed-mode ion exchange stationary phase for separation and analysis of PFAS compared to conventional reversed phase C₁₈ columns. Particularly, the isolator column of the present disclosure possessing a mixed-mode ion exchange stationary phase results in greater delay in retention time of background related PFAS compared to a conventional column. Consequently, contamination free chromatogram of PFAS analyte allows analysis of even trace level PFAS analytes.

What is claimed is:

1. A method of performing fluorinated compound analysis using a liquid chromatography system comprising an isolator column and an analytical column, the method comprising:
a. flowing a mobile phase through the isolator column;
b. introducing a liquid sample into the liquid chromatography system through a sample injection port, wherein the liquid sample comprises at least one type of fluorinated compound and the sample injection port is located downstream of the isolator column;
c. eluting the liquid sample through the analytical column such that at least one type of the eluted fluorinated compound is separated as a separated component; and
d. flowing the separated eluted component(s) to the detector, wherein the isolator column comprises a stationary phase material comprising a mixed mode with anion exchange surface chemistry.

2. The method of claim 1, wherein at least one type of fluorinated compound is a polyfluoroalkyl or perfluoroalkyl substance.

3. The method of claim 2, wherein the number of carbon atoms present in the polyfluoroalkyl substance is between 3 to 5.

4. The method of claim 2, wherein the number of carbon atoms present in the polyfluoroalkyl substance is more than 5.

5. The method of claim 1, wherein at least one type of fluorinated compound comprises one or more phosphonate group(s).

6. The method of claim 1, wherein the analytical column comprises a stationary phase material comprising a mixed mode with anion exchange surface chemistry.

7. The method of claim 1, wherein the analytical column comprises a stationary phase material comprising a reversed phase surface chemistry.

8. The method of claim 7, wherein the analytical column comprises a stationary phase material comprising C₁₈ alkyl-bonded surface chemistry.

9. The method of claim 1, wherein the detector is for performing mass spectrometry.

10. The method of claim 9, wherein mass spectroscopy comprises a tandem quadrupole mass spectrometer or a time-of-flight mass spectrometer.

11. The method of claim 1, wherein an interior surface of the isolator column is coated with an alkylsilyl coating.

12. The method of claim 1, further comprises quantification of at least one type of fluorinated compound after flowing the separated eluted component(s) to the detector.

13. The method of claim 1, wherein the concentration of at least one type of fluorinated compound in the liquid sample is less than 0.1 ng/L.

14. A method of delaying retention time of a contamination in liquid chromatography system comprising an isolator column and an analytical column, wherein the contamination comprises at least one type of first fluorinated compound, the method comprises:
a. flowing a mobile phase through the isolator column, wherein the contamination is present in the system prior to the isolator column;
b. introducing a liquid sample into the liquid chromatography system through a sample injection port, wherein the liquid sample comprises at least one type of second fluorinated compound and the sample injection port is located downstream of the isolator column;
c. eluting the liquid sample through the analytical column such that at least one type of the eluted fluorinated compound is separated as a separated component; and
d. flowing the separated eluted component(s) to the detector such that at least one type of second fluorinated compound reaches the detector prior to the at least one type of first fluorinated compound, thereby the retention time of the contamination is delayed at least 1 minute compared to the retention time of at least one type of second fluorinated compound.

15. The method of claim 14, wherein the isolator column comprises a stationary phase material comprising a mixed mode with anion exchange surface chemistry.

16. The method of claim 14, wherein the retention time of the contamination is delayed at least 5 minutes compared to the retention time of at least one type of second fluorinated compound.

17. A method for performing fluorinated compound analysis using a liquid chromatography system including an isolator column and an analytical column, the method comprising:
a. flowing a mobile phase through the isolator column;
b. introducing a liquid sample into the liquid chromatography system through a sample injection port, wherein the liquid sample comprises at least one type of fluorinated compound and the sample injection port is located downstream of the isolator column;
c. eluting the liquid sample through the analytical column such that at least one type of the eluted fluorinated compound is separated as a separated component; and
d. flowing the separated eluted component(s) to the detector, wherein at least one column comprises a stationary phase material possessing a mixed mode with anion exchange surface chemistry.
